(19) United States
(12) Patent Application Publication
(10) Pub. No.: US 2005/0225909 A1
(43) Pub. Date: Oct. 13, 2005

(54) Leakage monitoring system

(75) Inventors: Akio Yoshizaki, Seiro (JP); Naohiro Takakamo, Shibata (JP); Satoko Gotou, Nigata (JP); Hideki Hayakawa, Nakajo (JP); Tetsunori Watanabe, Niigata (JP); Haruki Shibuya, Asahi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi Industrial Equipment Co., Ltd., Chiba (JP)

(21) Appl. No.: 10/920,680

(22) Filed: Aug. 18, 2004

(30) Foreign Application Priority Data
Apr. 9, 2004 (JP) 2004-114882

(51) Int. Cl. H02H 3/00

(52) U.S. Cl. 361/42

(57) ABSTRACT

The system makes it possible to monitor various electrical variables by using a simple structure at low cost with ease and with high reliability by a circuit breaker which jointly includes a current transformer to detect current, a transformer to detect voltage, and a zero-phase current transformer to detect leakage current, in addition to the switch controller to perform the basic function of the circuit breaker. Moreover, the system also provides a function to display various measured values, obtained as described above, by a display unit that can be detached and installed separately from the measuring section to display data sent in digital form by data transmission.

### BACKGROUND OF THE INVENTION

The present invention relates to technology for monitoring the state of a circuit breaker, and more particularly to technology by providing a zero-phase current transformer in the circuit breaker, measuring an leakage current of the active current included in the secondary output current, performing arithmetic operations in the circuit breaker, and transmitting data in digital form to a host system or to subordinate equipment.

Further, the present invention also is concerned with technology for checking if a monitoring device itself operating normally during leakage current measurement by the monitoring device connected to the circuit breaker including a zero-phase current transformer.

Further, the present invention is concerned with an insulation monitoring system to keep track of the state of the insulation.

Further, the present invention relates to a device for monitoring the circuit-breaker's inside-temperature, leakage current, and the temperature and humidity internal and external to the power board, in which the circuit breaker is mounted, in respective load equipment to which electric power is distributed through the circuit breaker, and more particularly relates to a single monitoring device capable of monitoring composite maintenance information about a plurality of circuit breakers.

Further, the present invention relates to an insulation monitoring system to monitor the state of the insulation.

Apart from the present invention, an example of a conventional electronic circuit breaker with a measuring function is disclosed in JP-A-11-8930. Another conventional circuit breaker with a function of measuring leakage current is disclosed in JP-A-2002-289085.

FIG. 2 is a block diagram showing an outline of the technology in JP-A-11-8930. In FIG. 2, the number 20 denotes a circuit breaker, 1 denotes a switch controller, 2 denotes a power-receiving side terminal part, 3 denotes a load-side terminal part, 4 denotes a transformer for measurement, 5 denotes a current transformer for measurement, 6 denotes a power supply circuit part, 7 denotes a current and voltage measuring circuit part, 8 denotes a CPU part, 11 denotes a display part, 12 denotes a communication I/F part, 13 denotes a communication terminal part, 14 denotes a host system, 15 denotes a measurement output part, 200 denotes a switch mechanical part, 201 denotes a current transformer for control, 202 denotes a rectifier circuit part, 203 denotes a current-detection power circuit part, 204 denotes an instantaneous-trip circuit part, 205 denotes a tripping device, 206 denotes a time-characteristic control circuit part, 207 denotes a time-characteristic setting part, and 208 denotes an alarm display part.

The circuit breaker includes, besides a switch controller as the main function thereof, a current transformer to detect a current passed through the circuit breaker, a transformer to detect a voltage, a power supply circuit part to receive the current and voltage detected by the transformer and the current transformer, a current and voltage measuring circuit, a CPU for calculating a current value, voltage value, electric power value, value of power consumed, and power factor value from current and voltage measured, a display part for displaying measured values, and a communication I/F part for converting measured values into output signals and sending the signals to a host system.

The outline structure of the circuit breaker in JP-A-2002-289085 is as follows. In FIG. 2 showing the schematic diagram of JP-A-11-8930, the current transformer 5 for measurement is replaced by a zero-phase current transformer for measurement, and the current transformer for control 201 is replaced by a zero-phase current transformer for control. The circuit breaker includes, besides the switch controller as the main function thereof, a zero-phase current transformer to detect a leakage current of a current passed through the circuit breaker, a transformer to detect voltage, a power supply circuit part to receive a leakage current and a voltage detected by the zero-phase current transformer and the transformer, a leakage current and voltage measuring circuit, and a CPU for performing arithmetic operations on measured values.

In JP-A-11-8930 and JP-A-2002-289085, only either the current transformer or the zero-phase current transformer is provided. In JP-A-2002-289085, the communication function is not provided.

In contrast to the present invention, conventionally, a earth leakage breaker has been installed in the distribution boards and switch boards to prevent power leakage accidents. In important facilities, however, arrangement has been made such that even when an earth leakage occurs, the circuit is not broken, but instead an alarm is activated to call the operator's attention. Further, much ingenuity is exercised, such as setting an alarm level in the earth leakage breaker, so that when a leakage current is larger than a preset alarm level, a predictive alarm is issued. For example, a circuit breaker with an earth leakage circuit-breaking function has been created which has an insulation failure detector contained in the circuit breaker, and watches out for changes in leakage current.

The earth leakage breaker such as this is provided with a test button to test if the earth circuit breaker itself detects a earth leakage normally or if a predictive alarm or an earth leakage circuit-breaking function takes place normally. For example, there has been proposed an earth leakage breaker with a remote test switch connected in parallel with the test button, to make it possible to perform a remote circuit-breaking test. Those examples are described in JP-A-5-252646 and JP-A-8-106844.

In contrast to the present invention, FIG. 9 shows the structure of a conventional insulation monitoring system. In FIG. 9, the number 47 denotes a circuit breaker to make or break the main circuit, 48 denotes a zero-phase current transformer to detect a leakage current of the main circuit, and 49 denotes an insulation monitoring device to keep track the fundamental wave component by reducing the capacitance component of the leakage current to as little as possible. The circuit breaker 47 and the zero-phase current transformer 48 have been installed separately. For example, JP-A-8-285903 describes the structure in which the circuit breaker and the zero-phase current transformer are disposed separately in the insulation monitoring system.

In contrast to the present invention, in monitoring the breaker temperature, the circuit breaker is checked for abnormal heat generation by making a tour of inspection at a rate of once a month, for example, on a thermo-label attached to the breaker. In this case, continuous monitoring is hard to keep up, with the result that symptoms of abnormality are sometimes overlooked.

With the monitoring device which detects temperature by a temperature sensor externally attached to the circuit breaker and outputs an alarm when abnormal heat is generated, temperature monitoring is carried out by measuring absolute temperatures, there is a problem that at the time of abnormal heat generation, the device does not pay attention to the magnitude of a load current in temperature management, and therefore it is difficult to output a timely alarm.

Among the leakage monitoring devices, some type can take inputs from a number of circuits, but there is no multiple-function monitoring device and, in other words, the leakage monitoring devices are mostly of single function type. There is demand for a compound type monitoring device.

Further, in contrast to the present invention, to monitor the insulation condition of the equipment, while a voltage is applied between the power line and the grounding point, a current is measured and the insulating condition is measured. Devices of this kind are disclosed in JP-A-2003-215196 and JP-A-2004-64896.

### SUMMARY OF THE INVENTION

In the devices for monitoring the circuits, it has been required that they should include the function of measuring a leakage current in addition to current, voltage, electric power, power consumed, and power factor. If it is made possible to measure all those variables by the sensors contained in the circuit breaker, across-the-board monitoring becomes possible with ease at low cost.

By providing this circuit breaker with a communication circuit with the host system and the subordinate equipment, it becomes possible to implement centralized monitoring of leakage current of active current in time series.

In transmission of data to the display on the circuit breaker, data is sent in digital form after calculation at the measuring section.

The present invention has as its object to solve the problem of the prior art and to obtain measured values with high reliability by using a simple structure.

In the prior art, emphasis is placed on detecting a leakage current and breaking the load circuits. However, the deterioration of the insulation in the load circuits can be detected by monitoring over a long period of time and it is necessary to keep track on leakage current. In other words, it is required to measure the leakage current and display it in numerical values. In the prior art, the measuring function to this end is insufficient, and when the leakage current is very small (0.0 mA or so, for example), it is not clear whether measurement was done accurately or there was some failure in the monitoring device. If some part subject to changes with time is used in the monitoring device, large measurement errors will occur, which makes calibration necessary; however, this is almost impossible after the monitoring device was installed. Moreover, with a distribution board or a power switchboard including the above-mentioned monitoring device, because a leakage current is not produced, inspection at shipment cannot be carried out on each individual product, or if a simulation circuit is organized, it will inevitably become a full-fledged work. The present invention has been made to solve this problem.

In the prior art, the circuit breaker and the zero-phase current transformer are installed separately, so that a large space is required for installation and because the wires are passed through the zero-phase current transformer, this adds up to many man-hours. If an insulation monitoring system is to be applied to the existing circuit, there is a possibility that this is impossible due to a shortage of space.

The problem to be solved by this invention is to provide an insulation monitoring system which is securely applicable even to the existing circuit without increasing the installation space and man-hours.

The present invention provides a monitoring device which detects temperature with a temperature sensor built in the circuit breaker, and which can also extract a load current, a zero-phase current, and the external temperature and humidity, wherein monitoring of an abnormally generated heat temperature corresponding to a load current, monitoring of a leakage current, and abnormality monitoring of temperature and humidity internal to and external to the distribution board can be performed on a single monitoring device, and wherein an alarm output function and a communication function are also provided.

In the prior art, for insulation monitoring, only the leakage current of the relevant circuit is generally extracted and measured, but, in actuality, the leakage current of a resistive component which has characteristics analogous to those of the insulation resistance is not generally measured.

There is a device which receives a voltage and measures a leakage current of the resistive component from a voltage component and the leakage current, but the actual situation is that only a voltage component of one circuit and a leakage current of one circuit are generally measured.

The problem of the present invention is to provide a system for economically monitoring the insulation of multiple banks and multiple circuits.

The actual state is that in the prior art, there is the contact mechanism in the insulation monitoring device but it is used as an alarm contact.

In the case of the circuit breaker, general practice is that an earth leakage is detected in the leakage breaker, the contact mechanism in the leakage breaker is operated, and the tripping mechanism in the leakage breaker is used to trip the switch.

In the present invention, the problem is to combine the insulation monitoring device with the circuit breaker, use the insulation monitoring device to monitor and record leakages at all times, and protect the power receiving and distributing system when the leakage current is larger than a threshold value.

In the prior art described above, there was a problem that unless a voltage was applied, the insulation state could not be measured. The object of the present invention is to monitor the operating state and the insulation condition of the facilities at all times without applying a voltage.

To achieve the above object, the device—(1) Provides, in addition to the switch controller as the basic function of the circuit breaker, a current transformer to detect a current, a transformer to detect a voltage, and a zero-phase current transformer to detect a leakage current, and also provides a function to transmit measured values to the host system and the subordinate equipment.

(2) Provides a function to display reliable measured values obtained in (1) by a display part that can be easily detached and installed in a separate position to display digital signals which have undergone arithmetic operations in the measuring section and sent to the display part.

In the present invention, a zero-phase current transformer, through which the main conductors are passed, is contained in the circuit breaker, the secondary winding of the current transformer is drawn out to the terminal block, the calibration resistance and the calibration button are connected in series with the tertiary winding of the current transformer or the pass-through wires of the zero-phase current, and by operating the calibration button, when a voltage is applied and a predetermined calibration current is generated in the secondary winding of the current transformer, which can be checked by a monitoring device connected to the secondary winding.

The burden resistance (input resistance) provided in the monitoring device connected to the secondary winding of the current transformer may be adjusted to perform calibration.

Adjustment made to the burden resistance (input resistance) provided in the monitoring device connected to the secondary winding of the current transformer may be communicated through the communication function in the monitoring device to the host system to record data.

To solve the above-mentioned problem, in the present invention, a system is formed using the circuit breaker with a built-in zero-phase current transformer, wherein a zero-phase current transformer for detecting a leakage current of the power lines is contained in the circuit breaker which makes or breaks the power lines.

According to the present invention, there is provided a circuit breaker which permits a temperature sensor to be built therein, and which has a function of outputting an electric signal representing the temperature in the interior of the circuit breaker.

In the present invention, it is arranged for one monitoring device to be able to introduce temperature information, zero-phase currents and load currents from a plurality of circuit breakers; therefore, it is possible to provide a monitoring device which can check a temperature with respect to a load current and compare a leakage current with the load current, and which makes it possible to set an alarm level suitable for the actual load.

In the present invention, since it is made possible to take an external temperature and an external humidity, in response to an abnormal rise of the internal temperature or an excess humidity of the board, the monitoring device can output an alarm to the outside, and can also transmit data by the built-in communication function through a transmission line to display it in real time on the personal computer.

To solve the above-mentioned problem, the present invention provides a voltage waveform signal input part for inputting different voltages of at least two or more circuits, and means for calculating a leakage current of a resistive component in addition to a leakage current waveform.

To solve the above-mentioned problem, the monitoring device provides a contact mechanism in the leakage monitoring device and a tripping mechanism in the circuit breaker, and also provides means for connection.

To achieve the above object, in monitoring of the insulation condition of the facilities, the present invention comprises inputting a leakage current and a load operating signal, comparing signals with monitor values, and monitoring the operating state of each load, and thereby monitoring the insulation condition of the loads.

According to the present invention, because the monitoring device incorporates various sensors, such as a transformer, a current transformer, and a zero-phase current transformer, in the circuit breaker, it is possible to obtain various measured values with high reliability by using a simple structure.

Measured values can be shown on the display, and digital signals, after subjected to arithmetic operations, can be sent by data transmission to a computer, for example, and the display part can be easily detached and installed in a separate place.

Further, by monitoring measured values, particularly, a leakage current value, over an extended period of time, it becomes easy to take tabs on secular change in insulation deterioration and it is possible to perform inspection and maintenance in advance to preclude an accident.

Further, according to the present invention, by a monitoring device connected to the secondary winding of the zero-phase current transformer built in the circuit breaker, it is possible to measure changes in leakage current, grasp the insulation condition of the load circuit, and predict insulation deterioration, and by using a calibration button contained in the circuit breaker, determine whether the monitoring device makes measurements correctly. Even if a secular change has occurred in the parts in the monitoring device, it is easy to perform calibration. Moreover, it is easy to inspect a distribution board or a switchboard before shipment, so that trouble after installation at the site can be eliminated. By communication between the monitoring device and the host system, calibration records can be stored, and preventive maintenance and management with high reliability can be realized.

According to the present invention, an insulation monitoring system can be established without increasing the installation space and wiring man-hours for the zero-phase current transformer, and the present invention can be applied securely to the existing circuits.

According to the present invention, it is possible to monitor the deterioration of the circuit breaker.

According to the present invention, with a single insulation monitoring device, it is possible to implement insulation monitoring for multiple banks and multiple circuits, and an economical monitoring system can be established.

Further, according to the present invention, constant leakage monitoring and recording can be performed by the monitoring device, and a leakage trip can be set in the circuit breaker at low cost; consequently, it is possible to provide a system which integrates monitoring, recording and control.

Further, according to the present invention, because the insulation condition can be monitored without applying a voltage, the salient effect is that there is no need to provide a device for applying a voltage.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing a first embodiment of the circuit breaker with an insulation monitoring function of the present invention;

FIG. 2 is a block diagram showing a circuit breaker with a measuring function of prior art;

FIG. 3 is a characteristic diagram of a second embodiment showing an example of expanded function according to the present invention;

FIG. 4 is a diagram showing the electric circuit diagram of the circuit breaker incorporating a calibration button and a calibration resistance according to the first embodiment of the present invention, to which a leakage monitoring device is connected;

FIG. 5 is a block diagram of the leakage monitoring device according to the second embodiment of the present invention;

FIG. 6 is a diagram showing a leakage monitoring system formed by a circuit breaker and a leakage monitoring device according to a third embodiment of the present invention, added with a host system;

FIG. 7 is a block diagram of a fourth embodiment of the present invention;

FIG. 8 is a construction diagram of the fourth embodiment of the present invention;

FIG. 9 is a block diagram of prior art in contrast to claims 11 to 13, 24 and 25 of the present invention;

FIG. 10 is a block diagram of a fifth embodiment of the present invention;

FIG. 11 is a construction diagram of the fifth embodiment of the present invention;

FIG. 12 is an external appearance drawing of a zero-phase current transformer of a sixth embodiment of the present invention;

FIG. 13 is a sectional view of the zero-phase current transformer according to the fourth and fifth embodiments of the present invention;

FIG. 14 is a sectional view of the zero-phase current transformer according to the sixth embodiment of the present invention;

FIG. 15 is a layout diagram of the pass-through conductors of prior art in contrast to claims 11 to 13 of the present invention;

FIG. 16 is a layout diagram of the pass-through conductors according to a seventh embodiment of the present invention;

FIG. 17 is a construction diagram of the seventh embodiment of the present invention;

FIG. 18 is a block diagram of a eighth embodiment of the present invention;

FIG. 19 is a block diagram of a ninth embodiment of the present invention;

FIG. 20 is a block diagram of a tenth embodiment of the present invention;

FIG. 21 is a block diagram of the insulation monitoring device in an eleventh embodiment of the present invention;

FIG. 22 is a block diagram of signal input in the eleventh embodiment of the present invention;

FIG. 23 is an example of signal input in the eleventh embodiment of the present invention; and

FIG. 24 shows a method of calculating the load operating time in a twelfth embodiment of the present invention.

### DETAILED DESCRIPTION OF THE EMBODIMENTS

Modes of embodiment of the present invention will be described using some embodied examples with reference to the accompanying drawings.

### Embodiment 1

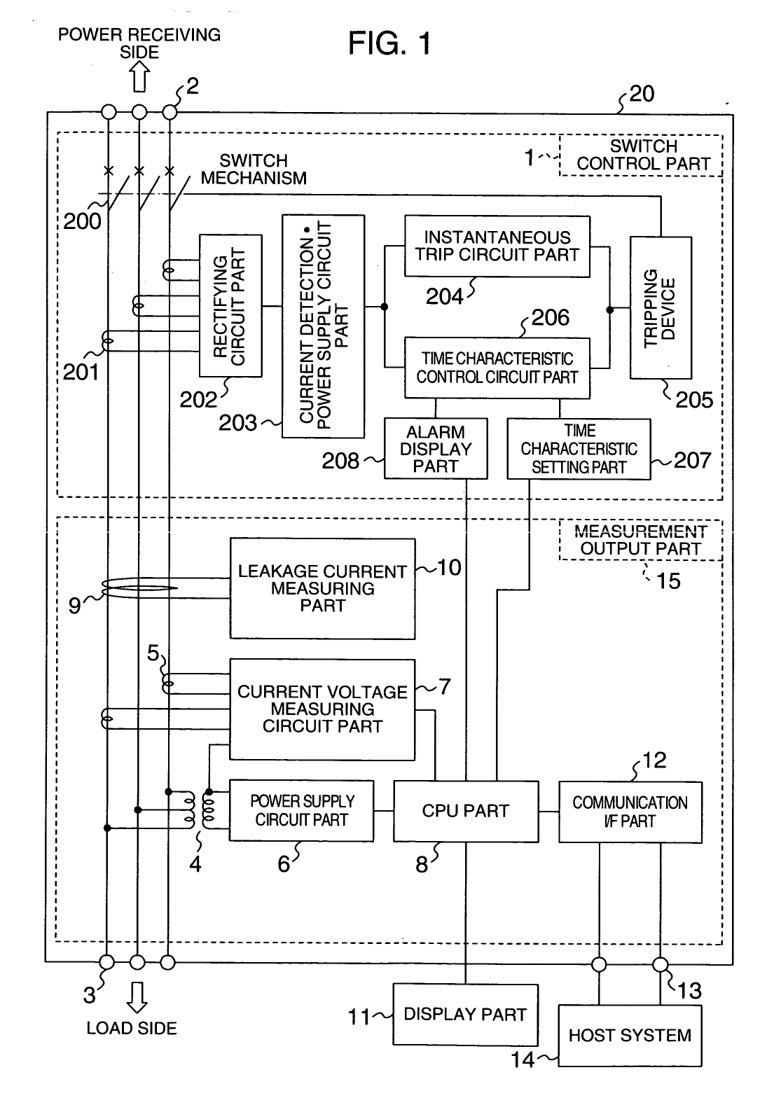

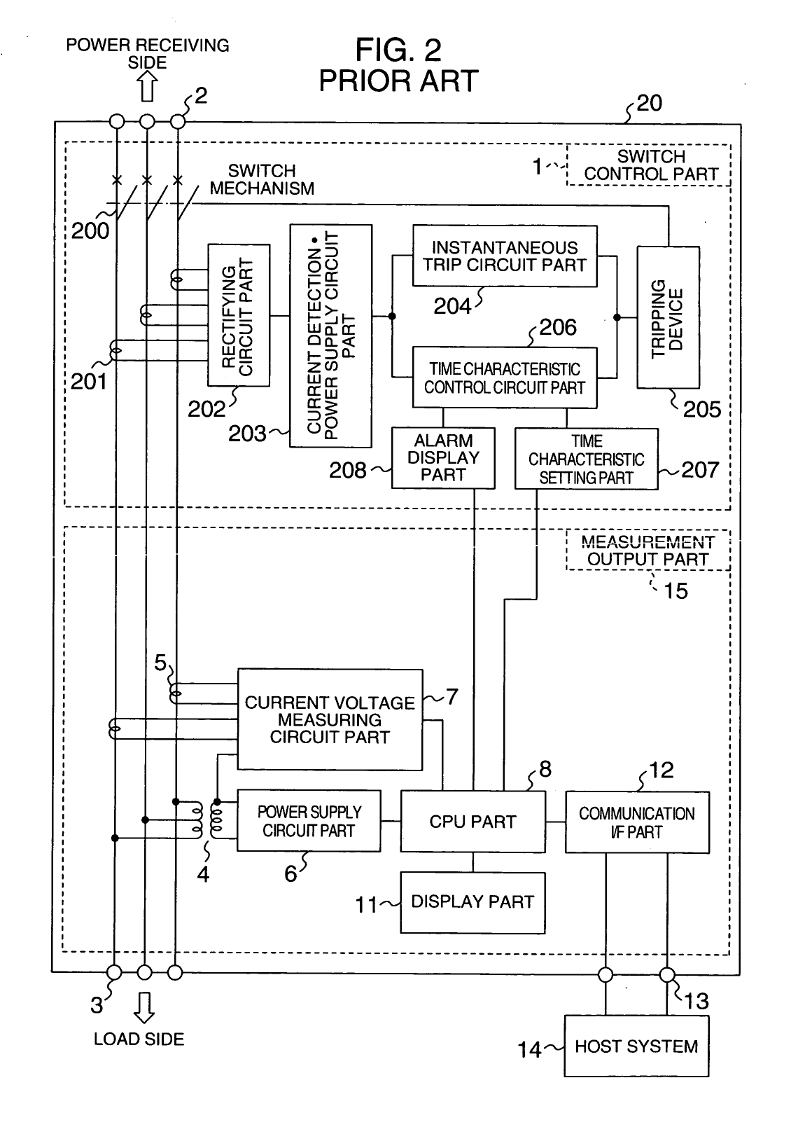

FIG. 1 shows an embodiment according to claims 1 to 6, and FIG. 2 is a block diagram showing a circuit breaker with a measuring function of prior art.

In FIGS. 1 and 2, the number 20 denotes a circuit breaker, 1 denotes a switch controller, 2 denotes a power-receiving-side terminal block, 3 denotes a load-side terminal block, 4 denotes a transformer for measurement, 5 denotes a current transformer for measurement, 7 denotes a current/voltage measuring circuit part, 8 denotes a CPU part, 11 denotes a display part, 12 denotes a communication I/F part, 13 denotes a communication terminal block, 14 denotes a host system, 15 denotes a measurement output part, 200 denotes a switching mechanical part, 201 denotes a current transformer for control, 202 denotes a rectifying circuit part, a 203 denotes a current detection power circuit part, 204 denotes an instantaneous-trip circuit part, 205 denotes a tripping device, 206 denotes time characteristic control circuit part, 207 denotes a time characteristic setting part, and 208 denotes an alarm display part.

In FIG. 1 showing an embodiment of the present invention, there is a block added to a circuit breaker with a measuring function shown in FIG. 2. This added block includes a zero-phase current transformer for measurement denoted by 9, and a leakage current measuring circuit part denoted by 10; more specifically, the zero-phase current transformer 9 detects a leakage current of a current which is passed through the circuit breaker, and the leakage current circuit part 10 draws a leakage current detected by the zero-phase current transformer.

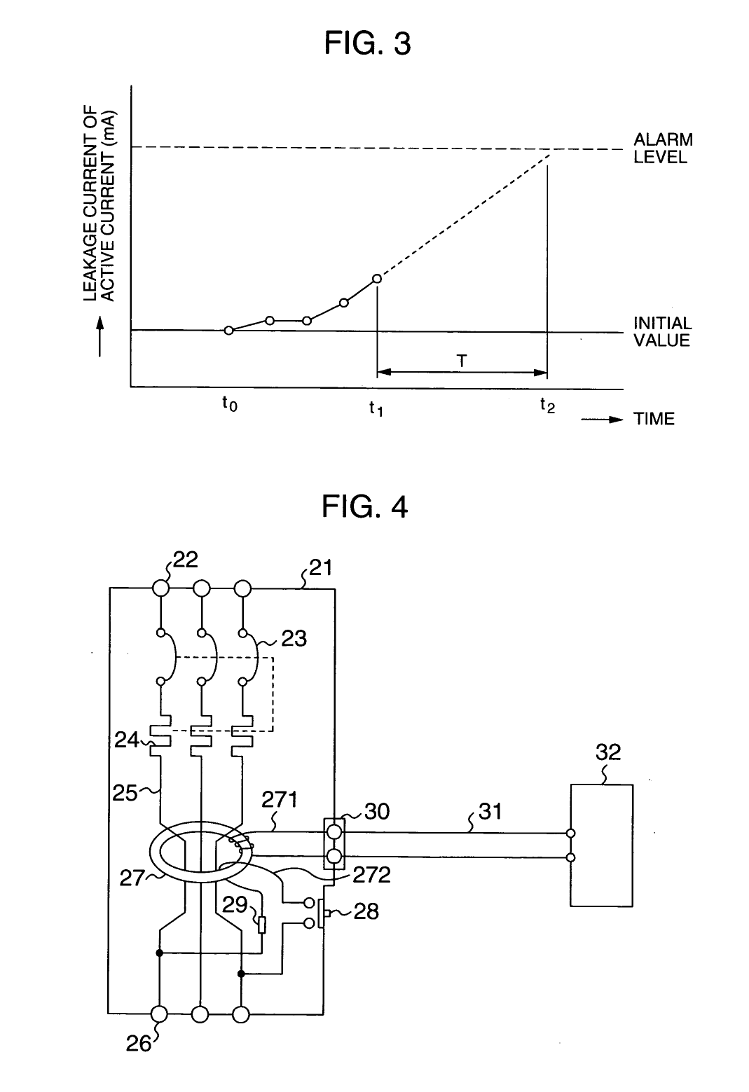

FIG. 3 is a characteristic diagram showing changes in the leakage current value with respect to time, in which the horizontal axis indicates time and the vertical axis indicates the active-current leakage current value (mA). In the above-mentioned first embodiment, the first object is to measure the leakage current value to check for deterioration of electrical insulation; however, generally, deterioration in electrical insulation does not occur in a short period of time, except for one-line ground leakage, but it occurs over an extended period of time. Therefore, if it is possible to estimate time when a preset alarm level is reached, it will be possible to formulate a plan for an electric power failure in advance, take measures such as replacing the parts where insulation deterioration may have developed, thereby preventing accidents, for example. In addition, since a communication I/F part is provided, it should be made possible to monitor measured values at a host system. By making such an arrangement, it becomes possible to watch out for insulation deterioration effectively without going out into the field.

### Embodiment 2

FIG. 4 shows the structure of the circuit breaker and a leakage monitoring terminal block according to claims 7 to 10 of the present invention. In FIG. 4, 21 denotes a circuit breaker, 22 denotes terminals connected to the power supply side, 23 denotes switch contacts, and 24 denotes bimetal elements to detect overcurrent and make the contacts 23 open when the load current is larger than a predetermined value. The number 25 denotes main conductors connecting the terminals 22 to terminals 26 on the load side, and the conductors 25 are arranged passing through a zero-phase current transformer 27, which will be described later. FIG. 4 shows the three main conductors passing through the zero-phase current transformer 27 to show a three-phase three-wire or single-phase three-wire circuit breaker. The number 27 denotes a zero-phase current transformer which includes a secondary winding 271 and a tertiary winding 272, and the secondary winding 271 is drawn out and connected to a terminal block 30. The number 28 denotes a calibration button as a salient feature of the present invention, which can be connected on one side to one end of the tertiary winding 272, and also connected on the other side to one of the main conductors 25. The number 29 denotes a calibration resistance which is connected on one side to the other end of the tertiary winding 272 and also connected on the other side to one of the main conductors 25. The tertiary winding 272, the calibration button 28, and the calibration resistance 29 mentioned above are connected in series. Under the condition that a voltage is applied between opposite ends of the main conductors, when the calibration button is depressed, a predetermined current, which depends on the calibration resistance, flows through the tertiary winding 272, and a predetermined current is generated in the secondary winding 271. For example, if the number of turns of the tertiary winding 272 is one and the number of turns of the secondary winding 271 is 1000 and the calibration resistance is 20 kΩ and the voltage is 200V, a current of 10 mA flows through the tertiary winding 272 and 0.05 mA is generated in the secondary winding 271, while 10 mA/1000 turns and by this current, the monitoring device 32 connected to the terminal block 30 by connection lines 31 can confirm the operation of the circuit breaker. By the way, the monitoring device may be a leakage current relay or a leakage current measuring device. The tertiary winding of the zero-phase current transformer may be a through type line formed outside the zero-phase current transformer.

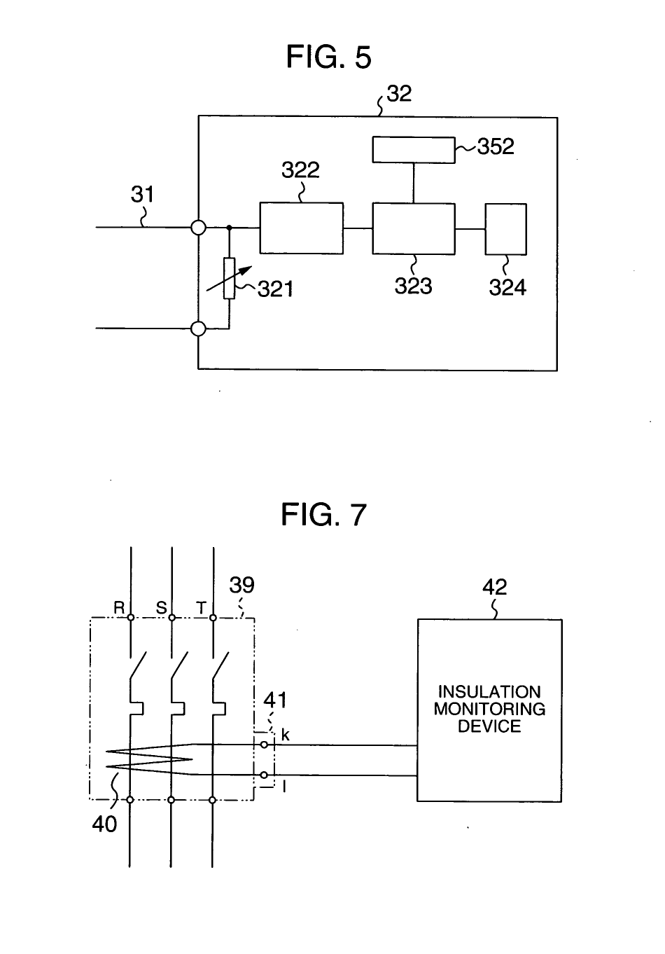

The monitoring device will be described with reference to FIG. 5. The number 321 denotes a burden resistance (input resistance), which converts the current of the secondary winding 271 of the above-mentioned current transformer into a voltage. Since the monitoring device includes an amplifier 322, a converter 323, a display part 324, and an operation part 325, this voltage is converted into a through-current value of the zero-phase current transformer 27 and displayed, namely, 10 mA is displayed. Here, as the (detected) through-current of the zero-phase current transformer 27, by depressing the calibration button 28, the current of the tertiary winding 272 is detected; however, normally, leakage current on the load side connected to the main conductors is detected. Description will now be made of the burden resistance 321. The burden resistance 321 is formed by a variable resistance, and if the above-mentioned predetermined current value does not agree with a displayed value, adjustment is performed to make them coincide with each other under the condition that the calibration button is depressed. As the calibration button, a reversing type button is suitable. The burden resistance 321 is a variable resistance with the finger grip provided on the front face of the leakage monitoring device.

### Embodiment 3

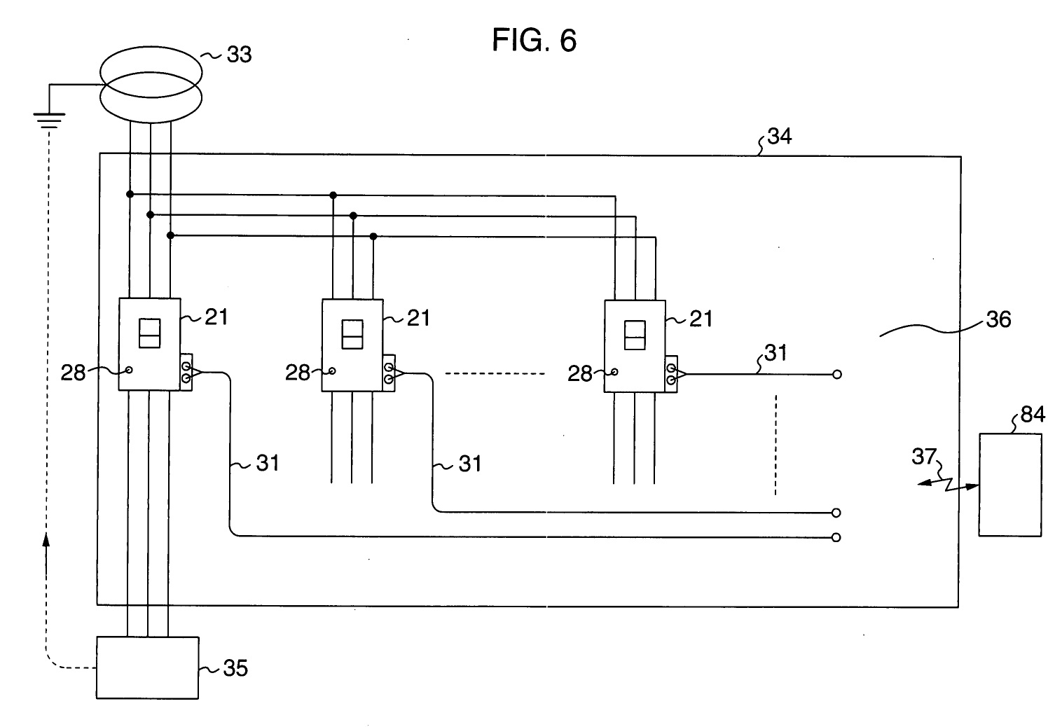

FIG. 6 shows a leakage monitoring system including the circuit breaker and the leakage monitoring device. The number 33 denotes a transformer, and 34 denotes a power distribution board, which includes a plurality of circuit breakers 21 described above. The number 36 denotes a leakage monitoring device for multiple circuits based on the above-mentioned leakage monitoring device 32 and adapted to monitor a plurality of circuit breakers 21 by increasing the number of inputs. This leakage device is added with a communication function. The number 37 denotes communication media, and 38 denotes a host system, such as a personal computer. The number 28 denotes calibration buttons arranged to be operated on the front faces of the circuit breakers 21. Each circuit breaker 21 is connected to the leakage monitoring device 36 for multiple circuits. In the system configured as described, in the real operating state, electric power is supplied from the transformer 33 to the load equipment 35 through the circuit breakers 21, and the leakage monitoring device 36 for multiple circuits constantly monitors and measures output current of the secondary winding 271 of the current transformer 27 contained in each circuit breaker 21. Meanwhile, in the stage of manufacturing and shipping the power distribution board, though it is necessary to inspect individual distribution boards, there is neither transformer 33 nor load equipment 35 nor leakage current. So, the following procedure is carried out. Instead of using the transformer 33, a commercial power source is connected, and the circuit breakers 21 are closed, but even though current measurement is performed by the monitoring device, the value 0 is displayed; therefore, by depressing the calibration button 28 on each of the circuit breakers 21 mentioned above, it is checked that the predetermined current value is displayed. By checking in this manner on all of the circuit breakers 21 and inputs to the leakage monitoring device 36 for multiple circuits, it is confirmed that measurement and monitoring are carried out normally. In an actual operation after the distribution board was shipped and installed, normal operation is checked as has been described. However, the state of deterioration in electrical insulation can be grasped by continued measurement and monitoring over an extended period of time, and if a secular change should have occurred in the component parts in the monitoring device, the burden resistance of the leakage monitoring device 36 for multiple circuits is calibrated by the calibration button 28, and the execution of calibration is communicated to a host system from the operation part 325. With regard to the contents of communication, if the number peculiar to the leakage monitoring device and calibration information are communicated, they are recorded added with a calibration date at the host system.

### Embodiment 4

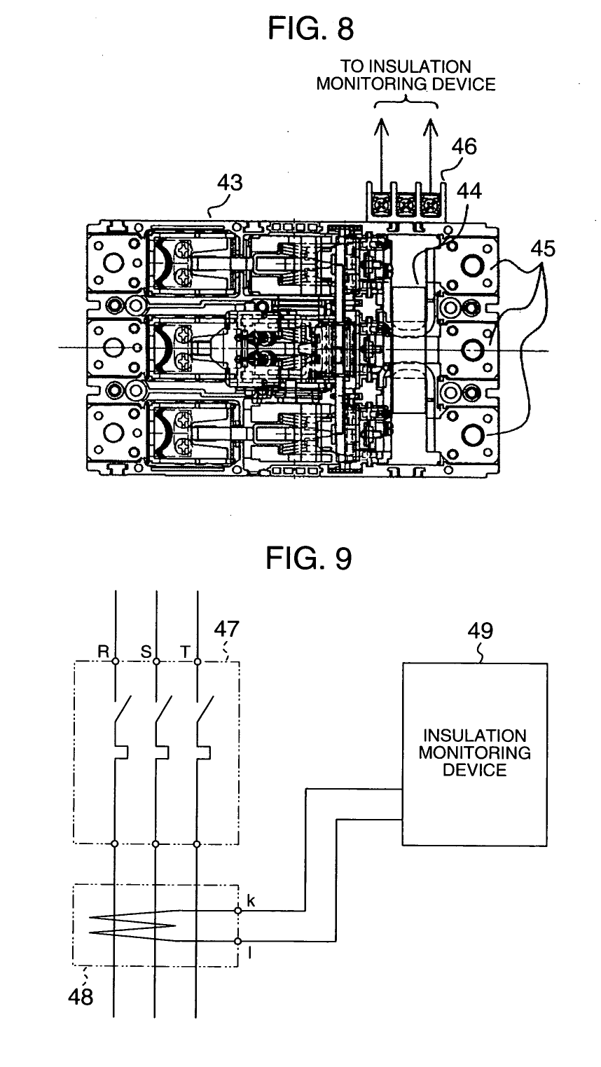

FIGS. 7 and 8 are diagrams for explaining an embodiment set forth in claims 11 to 13 of the present invention. In FIG. 7, the number 39 denotes a circuit breaker to make or break the main circuit, 40 denotes a zero-phase current transformer built in the circuit breaker 39, 41 denotes a terminal block to which output signal lines of the zero-phase current transformer 40 are connected, 42 denotes an insulation monitoring device for monitoring the fundamental wave component of the leakage current by reducing a capacitive component to as little as possible.

The zero-phase current transformer 40 is built in the circuit breaker 39, and output signals of the zero-phase current transformer 40 in the circuit breaker 39 are introduced through the terminal block 41 into the insulation monitoring device 42 to monitor the insulation condition. The dimensions of the circuit breaker 39 are the same as those of a prior-art circuit breaker 47 shown in FIG. 9. For this reason, the installation space for a prior-art zero-phase current transformer 48 becomes unnecessary, which makes possible saving on the space, and the wiring work for passing wires through the zero-phase current transformer also becomes unnecessary, which makes possible a reduction of wiring man-hours. Another advantage is that the dimensions of the circuit breaker are the same with respect to the existing circuits, making possible replacement by the circuit breaker according to this embodiment without any additional change, a fact which facilitates the introduction of this insulation monitoring system.

FIG. 8 is a construction diagram of the embodiment shown in FIG. 7.

In FIG. 8, the number 43 denotes a circuit breaker to make or break the main circuit, 44 denotes a zero-phase current transformer built in the circuit breaker 43, 45 denotes pass-through conductors passing through the zero-phase current transformer, and 46 denotes a terminal block to which the output signal terminals of the zero-phase current transformer 44.

The zero-phase current transformer 44 is contained in the circuit breaker, and the pass-through conductors 45 pass through the zero-phase current transformer 44, the output signal lines are connected to the terminal block 46, by which wires can be connected to the insulation monitoring device.

### Embodiment 5

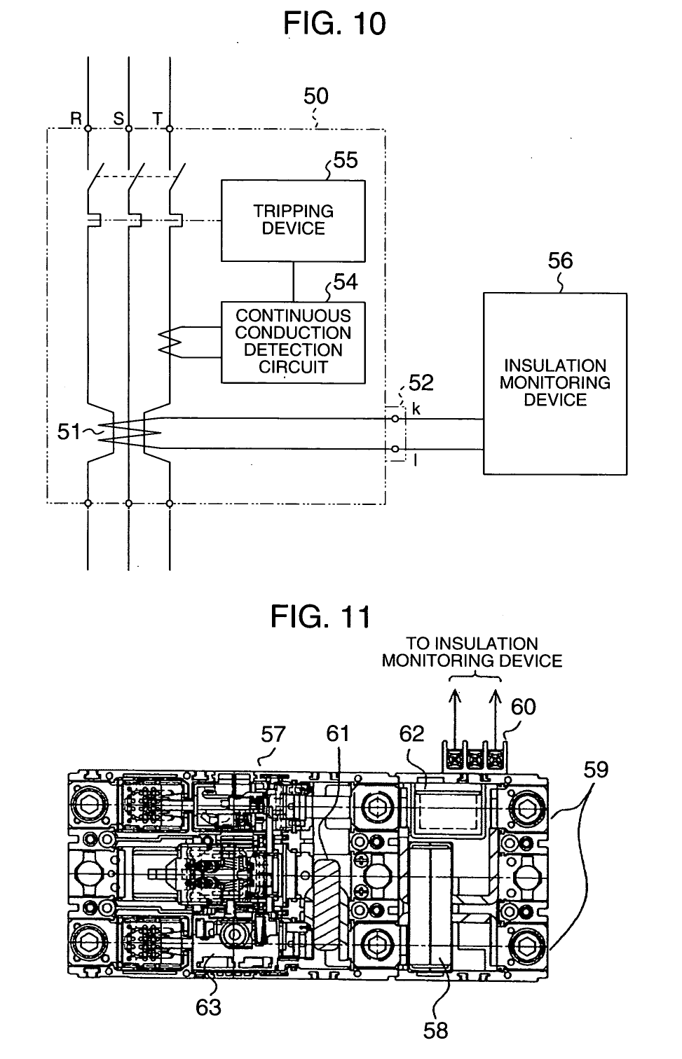

FIGS. 10 and 11 are diagrams for explaining an embodiment set forth in claims 11 to 13 of the present invention. In FIG. 10, 50 denotes a circuit breaker to make or break the main circuit, 51 denotes a zero-phase current transformer contained in the circuit breaker 50, 52 denotes a terminal block having the output signal lines of the zero-phase current transformer 51 connected thereto, 53 denotes a current transformer to detect a main-circuit current, 54 denotes a continuous conduction detecting circuit to detect continuous conduction and output a trip signal, 55 denotes a tripping device, which receives a signal from the continuous conduction detecting circuit 54, trips the mechanical part of the circuit breaker 50, breaks the main circuit contact, and disconnects the circuit breaker, and 56 denotes an insulation monitoring device to minimize the capacitive component of the leakage current to thereby monitor the fundamental wave component.

Where the circuit breaker is in use for ordinary overcurrent or short-circuit protection, it is possible to compose an insulation monitoring system according to the first embodiment described above; however, in manufacturers using welding machines, auto manufacturers, for example, circuit breakers for welding machines are used. The circuit breaker for a welding machine is a breaker provided with a function to prevent continuous conduction to protect the welding machine and the welding object in addition to short-circuit protection. If the control unit for a welding machine is in normal condition, the circuit current is an intermittent current in which conduction and non-conduction alternate in set cycles. However, if some disorder occurs, such as a failure, in the control unit for the welding machine, the circuit current conducts continuously. To prevent this, the circuit breaker for a welding machine is provided with a continuous-conduction prevention function to turn off the circuit breaker when the circuit current has flowed longer than a preset time. For the reason described above, because the continuous-conduction prevention function is not provided in the first embodiment, the first embodiment cannot be applied in automobile makers, for example. In the second embodiment, the current transformer 53, the continuous-conduction detecting circuit 54, and the tripping device 55 are added to the structure of the first embodiment. The main-circuit current is converted into a minute current by the current transformer 53 and input to the continuous-conduction detecting circuit. When a current larger than a fixed value continued flowing longer than a set period of time, a signal from the continuous conduction detecting circuit is sent to the tripping device 55, which operates to turn off the circuit breaker 50.

According to the above arrangement, it is possible to introduce the insulation monitoring system improved in space and wiring savings to the circuit used for the welding machine.

FIG. 11 is a construction diagram of an embodiment shown in FIG. 5.

In FIG. 5, 57 denotes a circuit breaker to make and break the main circuit, 58 denotes a zero-phase current transformer contained in the circuit breaker 57, 59 denotes pass-through conductors passing through the zero-phase current transformer, 60 denotes a terminal block having output signal lines of the zero-phase current transformer 58 connected thereto, 61 denotes a current transformer to detect the main-circuit current, 62 denotes a continuous conduction detecting circuit to detect continuous conduction and output a trip signal, and 63 denotes a tripping device, which receives a signal from the continuous-conduction detecting circuit 62, trips the mechanical part of the circuit breaker 57, breaks the main-circuit contact, and turns off the circuit breaker.

### Embodiment 6

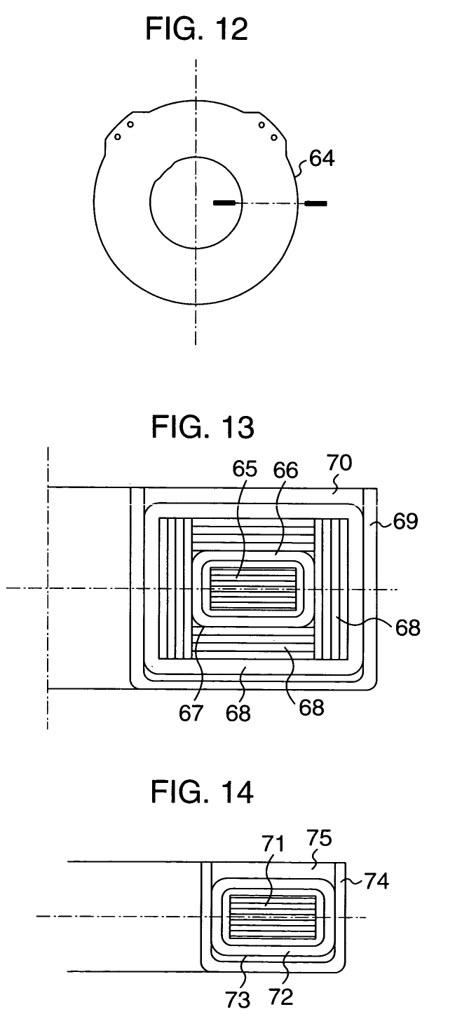

FIGS. 12, 13 and 14 are diagrams for explaining embodiments set forth in claims 11 to 13 of the present invention. FIG. 12 is an external view of the zero-phase current transformer, and FIGS. 13 and 14 are sectional views of the zero-phase current transformer, in which 65 and 71 denote the cores, 66 and 72 denote core cases, 67 and 73 denote windings, 68 denotes a magnetic shield, 69 and 74 outer cases, and 70 and 75 denote a filling material. In the first and second embodiments described, because the same zero-phase current transformer for an earth leakage breaker is shared, a large number of magnetic shield sheets 68 are mounted outside the core 65, the core case 66, and the winding 67 and all of them are set in the outer case 69, and filled on the outside with a filling material as shown in FIG. 13. With regard to the leakage breaker, the standard for the balance characteristic is stipulated in JIS C8371. The balance characteristic requires that even if a current six times the rated current flows in the leakage breaker (eight times when the rated current is 50A or less), the leakage breaker should not malfunction. To meet this characteristic, it is necessary to apply a magnetic shield to a zero-phase current transformer for a leakage breaker, and therefore the zero-phase current transformer is bound to become large in size and expensive in cost.

In this insulation monitoring system, because no leakage breaker is used, as shown in FIG. 13, it is not necessary to use a zero-phase current transformer with a magnetic shield, and as shown in FIG. 14, the circuit breaker contains the zero-phase current transformer dedicated to an insulation monitoring system in a much simpler structure such that the core 65, the core case 66, and the winding 67 are set in the outer case 74 and filled with a filling material 75, thus offering an advantage of cost savings.

### Embodiment 7

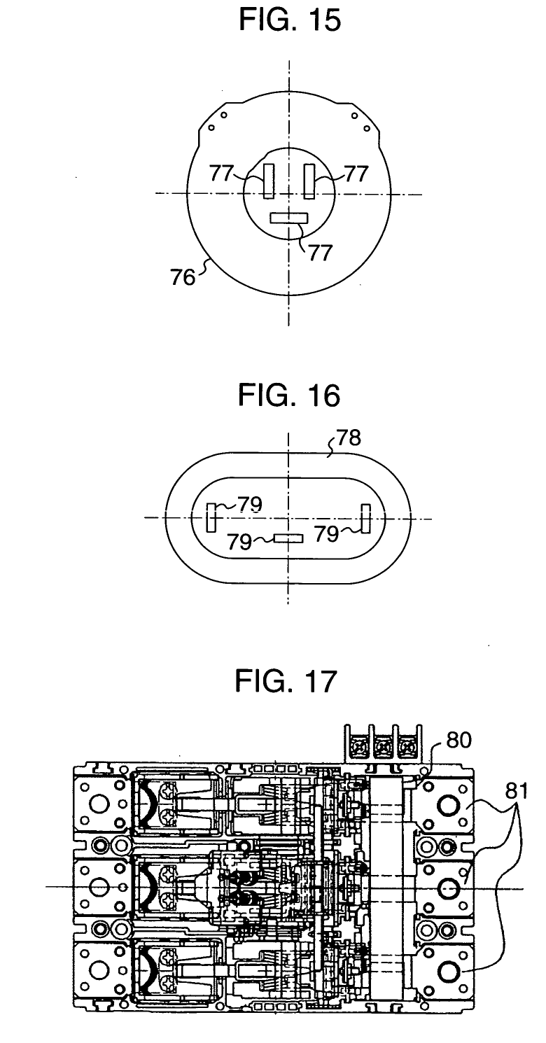

FIGS. 15, 16 and 17 are diagrams for explaining an embodiment set forth in claims 11 to 13 of the present invention. FIG. 15 is a layout diagram of the zero-phase current transformer and the pass-through conductors of the prior art, FIG. 16 is a layout diagram of the zero-phase current transformer and the pass-through conductors of the present invention, and FIG. 17 is a construction diagram of the present invention, in which 76, 78 and 80 denote the zero-phase current transformers, 77, 79 and 81 denote the pass-through conductors. In prior art, as shown in FIG. 15, to comply with the balance characteristic, the zero-phase current transformer is made in a regular circle form and the zero-phase current transformer are geometrically balanced when they pass through the center of the zero-phase current transformer. Therefore, as shown in FIG. 8, the pass-through conductors are bent to a large radius of curvature, with the result that it is difficult to pass the bent conductors through the zero-phase current transformer, and therefore the conductors are passed through in advance and then they are bent using a special-purpose fixture, which results in an increase of man-hours. In this invention, however, since it is not required to comply with the balance characteristic, the zero-phase current transformer is formed in an elliptic shape as shown in FIG. 16, by using straight pass-through conductors as shown in FIG. 17, it becomes easy to get the pass-through conductors through the zero-phase current transformer, making it possible to reduce man-hours.

### Embodiment 8

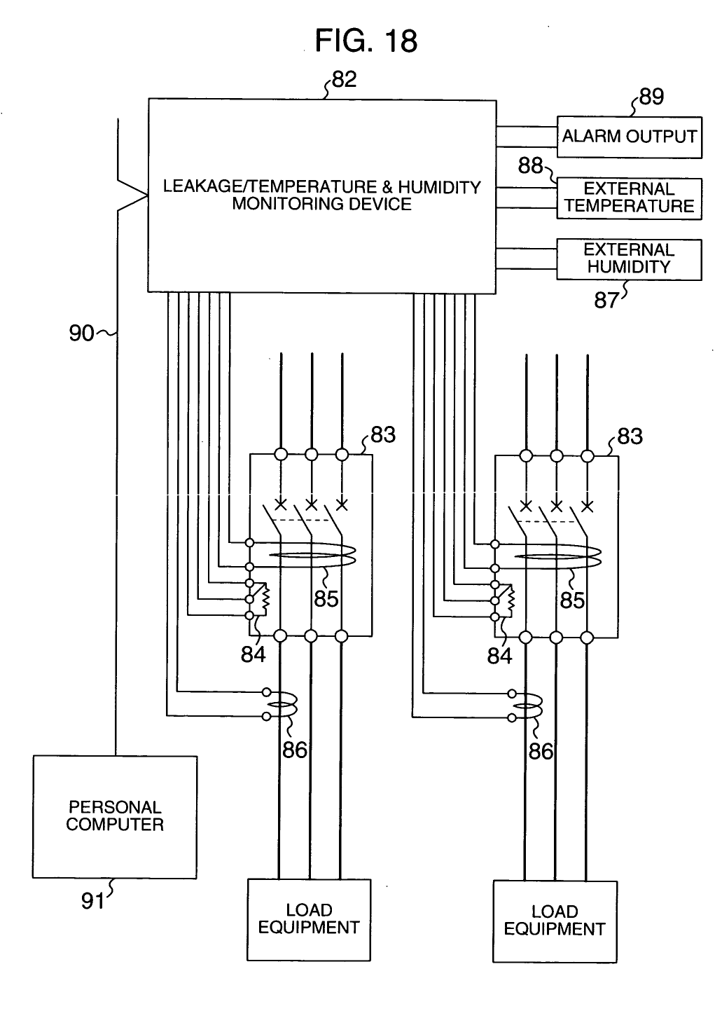

FIG. 18 is a block diagram related to claims 14 to 23 of the present invention.

In FIG. 18, 82 denotes leakage/temperature and humidity monitoring device, 83 denotes a circuit breaker, 84 denotes a temperature sensor contained in the circuit breaker 83, 85 denotes zero-phase current transformer contained in the circuit breaker 83, 86 denotes a current transformer installed on the power cable, 87 denotes an outside humidity sensor connected to the leakage/temperature and humidity monitoring device 82, 88 denotes an outside temperature sensor connected to the leakage/temperature and humidity monitoring device 82, 89 denotes an alarm output part connected to the leakage/temperature and humidity monitoring device 82, 91 a personal computer for transmitting and receiving information from the leakage/temperature and humidity monitoring device 82, and 90 denotes a transmission line connecting the personal computer to the leakage/temperature and humidity monitoring device 82.

The operation of the eighth embodiment will be described in the following.

The leakage/temperature and humidity monitoring device 82 constantly or intermittently calculates magnitudes of relevant variables from input signals from the temperature sensor 84 contained in the circuit breaker 83, the zero-phase current transformer 85 contained in the circuit breaker, and the current transformer 86 installed on the power line. From individual calculation results, the monitoring device 82 activates the alarm output part 89, or takes preventive measures according to a leakage current or temperature or a reciprocal relation between current and temperature.

Thus, it is possible to keep tabs on symptoms of abnormality that may occur in the circuit breakers or power lines.

Also, the alarm output part 89 can be actuated according to each sensor, such as, the outside humidity sensor 87 connected to the leakage/temperature and humidity monitoring device 82 and the temperature sensor 84 contained in the circuit breaker 83. Furthermore, by utilizing each sensor compositively, operation of the alarm output part 89 can be operated by a difference in temperature or humidity between the distribution board and the circuit breaker 83. In addition, the alarm output part 89 can be operated by comparison between above mentioned sensor and zero-phase current transformer 85 contained in the circuit breaker 83, each input signal to the current transformer 86 provided on the power line. Thus, it is possible to check symptoms or perform preventive maintenance before abnormality arises in the circuit breaker or the power cable.

The alarm output part 89 is provided outside the leakage/temperature and humidity monitoring device 82 in this embodiment, but even if it is mounted inside the leakage/temperature and humidity monitoring device 82, it is possible to expect that the same operation or effects can be obtained.

In this embodiment, whether the humidity sensor is mounted separately from or jointly with the temperature sensor 84 contained in the circuit breaker 83, the same preventive maintenance effects can be expected.

### Embodiment 9

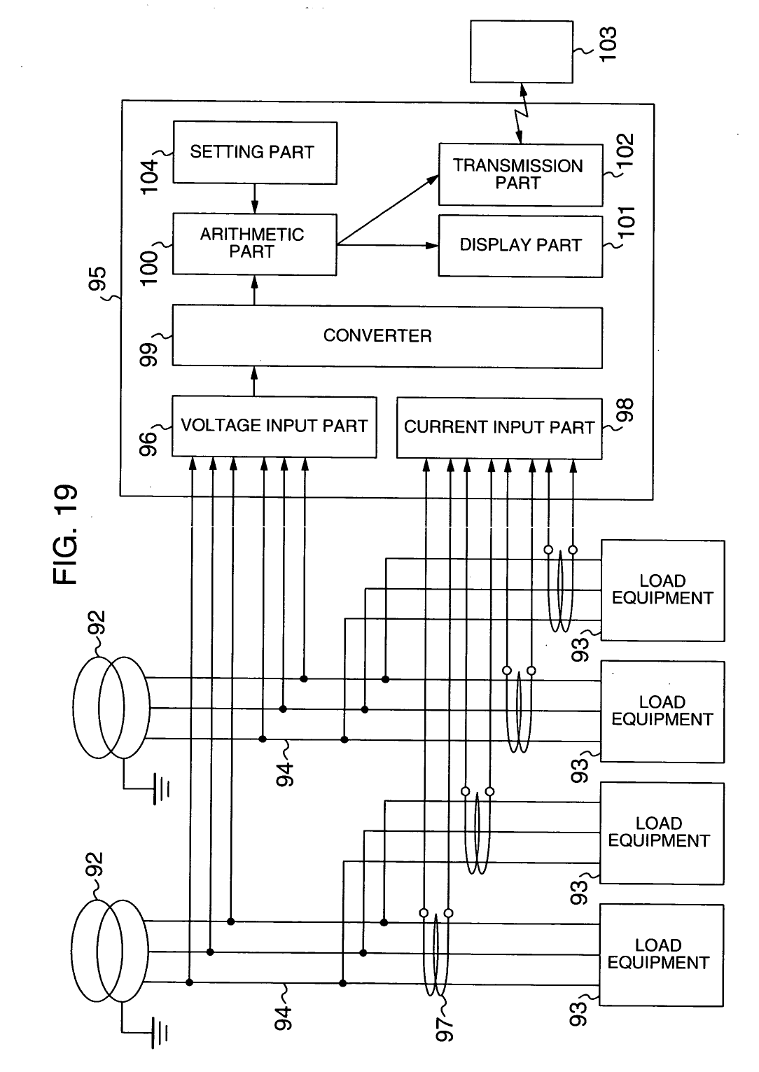

FIG. 19 is a block diagram according to an embodiment set forth in claim 24 of the present invention.

In FIG. 19, 92 denotes a transformer as a power supply system, 93 denotes load equipment, 94 denotes power lines between the transformer and the load equipment 93, 95 denotes a leakage monitoring device, 96 denotes a voltage input part in the leakage monitoring device 95 to input the voltages of the power lines, 97 denotes zero-phase current transformers to detect leakage of the power lines 94, 98 denotes a current input part in the leakage monitoring device 95 to input signals from the zero-phase current transformers 97, 99 denotes an A/D converter to convert signals from the voltage input part 96 and the current input part 98 into digital signals, 100 denotes an arithmetic part to perform arithmetic operation on digital signals from the A/D converter 99, 101 denotes a display part to display arithmetic operation results, etc. of the arithmetic part 100, 102 denotes a transmission part to transmit the operation results, etc. of the arithmetic part 100 to a host system, 103 denotes the host system, and 103 denotes a setting part in the leakage monitoring device 95.

The operation of this embodiment will be described in the following.

Generally, a plurality of power supply systems are used, and therefore there are a plurality of voltages, so that the power lines 94 are branched to power to the load equipment 93.

The voltage input part 96 receives a plurality of voltages as described above. The current input part 98 also receives leakage currents of the power lines of the voltage systems from which the voltage input part 96 receives voltages through the zero-phase current transformers 97.

Analog signals from the voltage input part 96 and the current input part 98 are converted into digital signals by the converter 99, and from these signals, the arithmetic part 100 calculates values such as an effective (rms) value.

Here, which current input parts 98 belong to which voltage systems are determined based on setting information from the setting part 104, thus making proper calculation possible.

Calculation results from the arithmetic part 100 are displayed by the display part 101 or transmitted to the host system 103 by the transmission part 102. The host system 103 acts as the user interface by displaying calculation results or performing settings, for example.

Thus, it becomes possible for the leakage monitoring device to monitor leakage of a plurality of circuits straddling a plurality of voltage systems.

### Embodiment 10

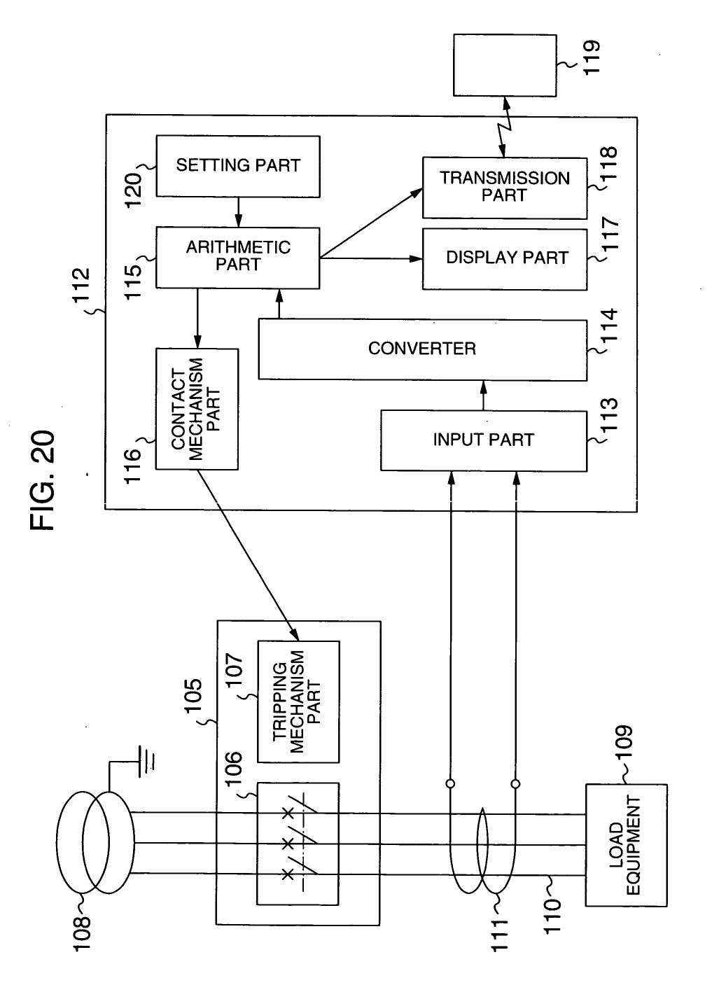

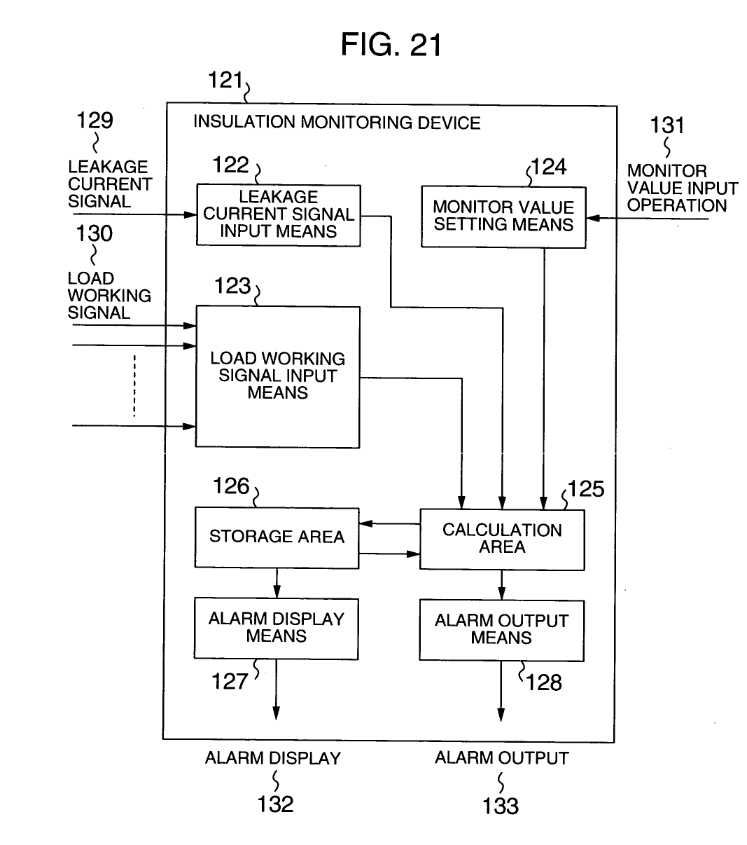

FIG. 20 is a block diagram of an embodiment set forth in claim 25 of the present invention.

In FIG. 20, 105 denotes a circuit breaker, 106 denotes a switch part contained in the circuit breaker 105, 107 denotes a tripping device contained in the circuit breaker, 108 denotes a transformer as a power supply system, 109 denotes load equipment, 110 denotes power lines transferring electric power from the transformer 108 to the load equipment, 111 denotes a zero-phase current transformer for detecting a leakage of the power lines 110, 112 denotes a leakage monitoring device, 113 denotes an input part to receive signals of zero-phase current transformer 111, 114 denotes a converter to convert signals from the input part 113 into digital signals, 115 denotes an arithmetic part to perform arithmetic operation on digital signals from the converter 114, 116 denotes a contact mechanism that operates according to calculation results from the arithmetic part 115, 117 denotes a display part that shows calculation results of the arithmetic part 115, 118 denotes a transmission part to transmit calculation results of the arithmetic part 115 to a host system, 119 denotes the host system, and 120 denotes a setting part contained in the leakage monitoring device 112.

The operation of the tenth embodiment will be described in the following.

When a ground leakage occurs in the power line 110 between the transformer 108 as the power supply system and the load equipment or a ground leakage occurs in the load equipment itself, the leakage can be detected by the zero-phase current transformer 111. A current flows through the secondary wiring of the zero-phase current transformer, which is proportional to the magnitude of the leakage current detected, the secondary wiring current of the zero-phase current transformer 111 is input to the input part 113 contained in the leakage monitoring device 112, and subjected to processing, such as amplification. After received by the input part 113, the current is converted into digital signals by the converter 114, and from the digital signals, the arithmetic part 115 calculates values, such as an effective (rms) value. In response to this calculation result, the contact mechanism 116 operates. Normally, the contact mechanism 116 is often used as an alarm means, such as a buzzer or a lamp. In the present invention, by the action of the contact mechanism 116, the tripping mechanism 107 of the circuit breaker 105 is actuated, and the switch part of the circuit breaker 105 is operated to switch over the switch part from the closed state to the open state.

Therefore, it becomes possible for the insulation monitoring device to check for and record leakage at all times, thereby making it possible to protect the electric power receiving and distributing system when a leakage current is larger than a threshold value.

### Embodiment 11

An embodiment set forth in claim 26 will be described with reference to FIG. 20.

Before starting measurement, in a monitor value input operation 131, by using a monitor value setting means 124, the monitor value of leakage current is set, sent through a calculation area 125, and stored in a storage area 126.

With regard to the measuring procedure, to begin with, in a leakage current signal input means 122, one cycle of a leakage current signal is divided into segments, and the segments are sampled and input at regular intervals, a leakage current is measured from the sampled data in the calculation area, and a measured leakage current is stored in the storage area. In a load operating signal input means, a load operating signal 130 is input from each load, and if the signal is OFF, a decision is made that the load is in the stopped state, and if the signal is ON, a decision is made that the load is in operation, the operation state of each load is stored in the storage area.

Then, in the calculation area 125, the measured leakage current value is compared with the set monitor value, and if the measured leakage current is larger than the monitor value, a decision is made that the leakage current is at an excess-abnormal level. In addition, when a decision is made that the leakage current is excessive and abnormal, by checking operating state of each load, a decision is made that insulation abnormality has occurred in the operating load. In the case where a decision is made that the leakage current is excessive and abnormal, an alarm is displayed at an alarm display means 127, and an alarm signal is output to the outside by an alarm output means 128.

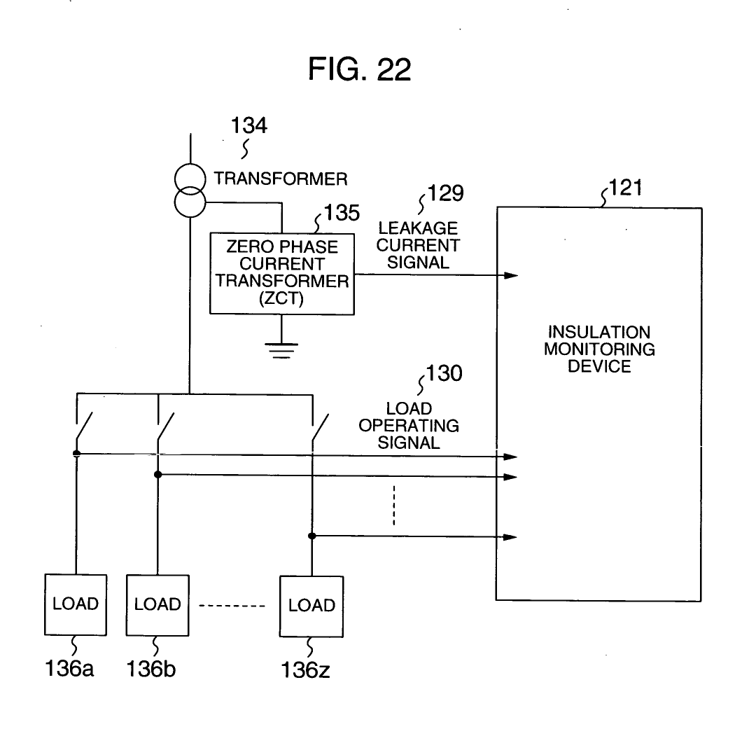

Description will now be made of an example of connection of the leakage current signal 129 and the load operating signal 130, which are input to the leakage monitoring device 121 with reference to FIG. 22.

The leakage current signal 129 is input from a zero-phase current transformer (ZCT) 135 installed at a transformer 134, and note that a leakage current is measured on all loads. The load operating signal 130 representing the operating state of a plurality of loads (loads 136a, 136b, and 136z, for example) is input in the form of ON/OFF signal.

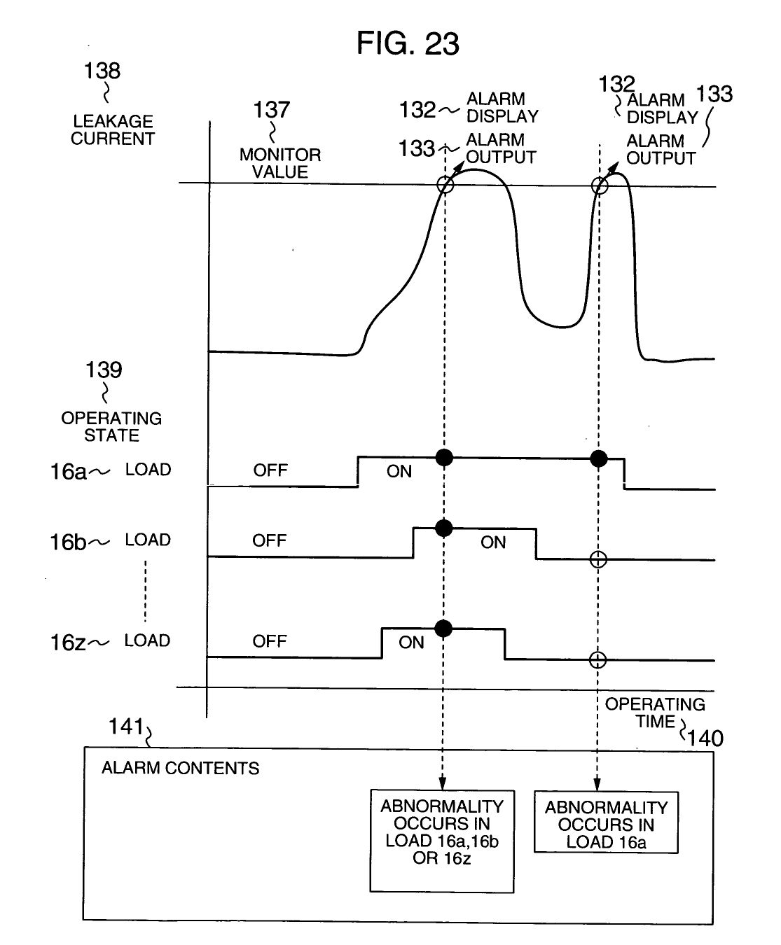

Referring to FIG. 23, description will be made of the method for deciding on leakage current excess-abnormality by the leakage monitoring device 121.

In the leakage monitoring device 121, the measured leakage current 138 is compared with the set monitor value 137, and if the measured leakage current 138 is larger than the monitor value 137, a decision is made that the leakage current is excessive and abnormal. When a decision was made that the leakage current is excessive and abnormal, the operating state of each load is checked, and if the operating loads are 136a, 136b and 136z, for example, a decision is made that insulation abnormality has occurred in the load 136a or 136b or 136z. To give another example, if the operating load is 136a only, a decision is made that insulation abnormality has occurred in the load 136a.

### Embodiment 12

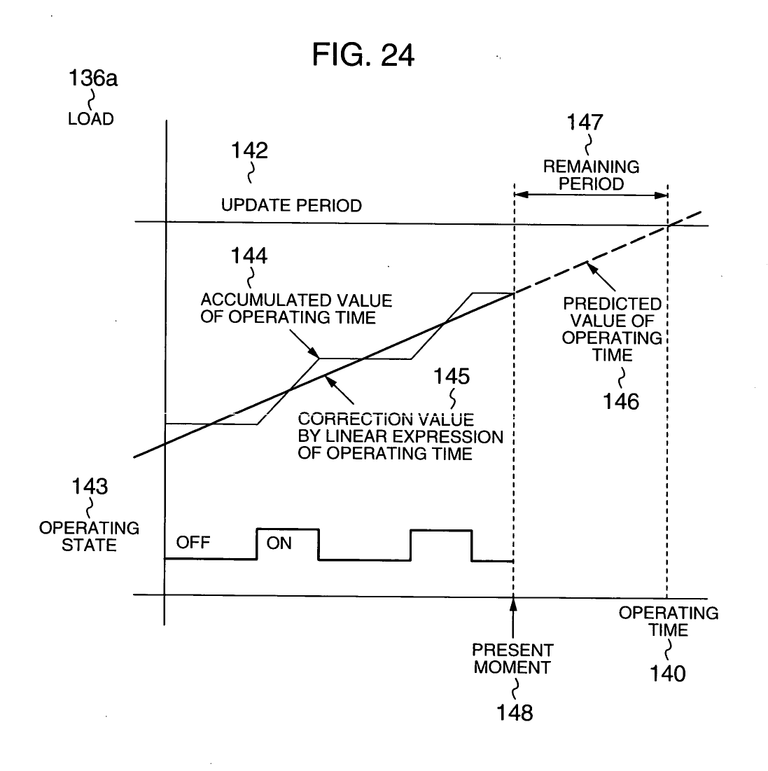

Description will be made of an embodiment set forth in claim 27 with reference to FIG. 24.

The operating state is input as ON/OFF signal from the load (load 136a, for example) according to the eleventh embodiment, and if the load is in operation, the cumulative value 144 of operating time is updated. The cumulative value 144 of operating time is corrected by using a linear expression, and a correction value 145 by a linear expression of operating time is calculated. By using the correction value 145 by a linear expression of operating time, a predicted value 146 of operating time is calculated, and the predicted value 146 is compared with a preset update period 142 to calculate a remaining period, by which it becomes possible to indicate a recommended replacement time for each load.

Leakage current due to insulation deterioration may cause a fire or a fatal accident, therefore it is important to raise the reliability of electric facilities for preventive maintenance.

It should be further understood by those skilled in the art that although the foregoing description has been made on embodiments of the invention, the invention is not limited thereto and various changes and modifications may be made without departing from the spirit of the invention and the scope of the appended claims.

1. A circuit breaker comprising:
a switch part for turning on and off a load current of a main circuit;
a load current detector for detecting a magnitude of said load current; and
a leakage current detector for detecting a magnitude of a leakage current of said load current.

2. A circuit breaker having a switch part for turning on and off a load current of a main circuit; and a leakage current detector for detecting a magnitude of a leakage current of said load current, further comprising:
an input part for inputting a signal detected by said leakage current detector;
a converter for converting said detected signal into a digital signal; and
an arithmetic part for calculating a leakage current from said digital signal.

3. The circuit breaker according to claim 2, further comprising:
a transmission part for sending and receiving a calculation result, etc. of said arithmetic part.

4. The circuit breaker according to claim 2, further comprising:
a display part for showing a calculation result, etc. of said arithmetic part.

5. The circuit breaker according to claim 2, further comprising:
a transmission part for sending and receiving a calculation result, etc. of said arithmetic part; and
a display part for showing a calculation result, etc. of said arithmetic part.

6. The circuit breaker according to claim 4, wherein said display part for showing a calculation result, etc. of said arithmetic part is detachable.

7. The circuit breaker according to claim 5, wherein said display part for showing a calculation result, etc. of said arithmetic part is detachable.

8. A circuit breaker having a switch part for turning on and off a load current of a main circuit; and a leakage current detector for detecting a magnitude of a leakage current of said load current, wherein a secondary winding of said leakage current detector is drawn out to a terminal block.

9. The circuit breaker according to claim 8, wherein a predetermined resistance and a confirmation button are connected in series with a tertiary winding of said leakage current detector or a pass-through line passing through said leakage current detector, and wherein by operating said confirmation button, a voltage is applied across a predetermined resistance and a predetermined calibration current is generated in said secondary winding of said leakage current detector.

10. A leakage current monitoring system formed by connecting a circuit breaker to a terminal block and a monitoring device, said circuit breaker comprising a switch part for turning on and off a load current of a main circuit; a load current detector for detecting a magnitude of said load current, and a leakage current detector for detecting a magnitude of a leakage current of said load current; an input part for inputting a signal detected by said leakage current detector; a converter for converting said detected signal into a digital signal; an arithmetic part for calculating a leakage current from said digital signal; an arithmetic part for calculating a leakage current from said digital signal; a transmission part for sending and receiving a calculation result, etc. of said arithmetic part; and a display part for showing a calculation result, etc. of said arithmetic part, wherein a calibration resistance and a confirmation button are connected in series with a tertiary winding of said leakage current detector or pass-through conductors passing through leakage current detector, and wherein by operating the confirmation button, a voltage is applied and a predetermined calibration current is generated in the secondary winding of said leakage current detector.

11. A leakage current monitoring system formed by connecting a circuit breaker to a terminal block and a monitoring device and also to a host system through communication lines, said circuit breaker comprising a switch part for turning on and off a load current of a main circuit; a load current detector for detecting a magnitude of said load current, and a leakage current detector for detecting a magnitude of a leakage current of said load current; an input part for inputting a signal detected by said leakage current detector; a converter for converting said detected signal into a digital signal; an arithmetic part for calculating a leakage current from said digital signal; an arithmetic part for calculating a leakage current from said digital signal; a transmission part for sending and receiving a calculation result, etc. of said arithmetic part; and a display part for showing a calculation result, etc. of said arithmetic part, wherein a calibration resistance and a confirmation button are connected in series with a tertiary winding of said leakage current detector or pass-through conductors for passing through said leakage current detector, and wherein by operating said confirmation button, a voltage is applied and a predetermined calibration current is generated in the secondary winding of said leakage current detector to thereby calibrate said monitoring device, and the calibration carried out is notified to said host system to record the calibration.

12. A circuit breaker comprising a switch part for turning on and off a load current of a main circuit, and a leakage current detector for detecting a magnitude of a leakage current of said load current, further comprising a continuous conduction preventive function to protect a welding machine and a welding object.

13. The circuit breaker according to claim 1, wherein a magnetic shield is reduced to prevent the occurrence of unbalance when a rush current six times the rated current flows through the zero-phase current transformer in the circuit breaker.

14. The circuit breaker according to claim 8, wherein a magnetic shield is reduced to prevent the occurrence of unbalance when a rush current six times the rated current flows through the zero-phase current transformer in the circuit breaker.

15. The circuit breaker according to claim 12, wherein a magnetic shield is reduced to prevent the occurrence of unbalance when a rush current six times the rated current flows through the zero-phase current transformer in the circuit breaker.

16. The circuit breaker according to claim 1, wherein the leakage current detector contained in said circuit breaker is elliptic in shape and the pass-through conductors passing through the leakage current detector are straight.

17. The circuit breaker according to claim 8, wherein the leakage current detector contained in said circuit breaker is elliptic in shape and the pass-through conductors passing through the leakage current detector are straight.

18. The circuit breaker according to claim 12, wherein the leakage current detector contained in said circuit breaker is elliptic in shape and the pass-through conductors passing through the leakage current detector are straight.

19. A circuit breaker having a switch part for turning on and off a load current of a main circuit, further comprising a temperature sensor.

20. The circuit breaker according to claim 19, wherein an output signal of said temperature sensor is coupled to a terminal block.

21. A circuit breaker having a switch part for turning on and off a load current of a main circuit, further comprising a humidity sensor.

22. The circuit breaker according to claim 21, wherein an output signal of said humidity sensor is coupled to a terminal block.

23. In an embodiment of a monitoring device including a circuit breaker set forth in claim 20; an input part for inputting a signal from said temperature sensor or a humidity sensor; a converter for converting said input signal into a digital signal; and an arithmetic part for calculating a temperature or a humidity from said digital signal, a monitoring system including a monitoring device, said monitoring device comprising a contact mechanism for moving contacts according to a calculation result by said arithmetic part,

24. In an embodiment of a monitoring device including a circuit breaker set forth in claim 22; an input part for inputting a signal from said temperature sensor or a humidity sensor; a converter for converting said input signal into a digital signal; and an arithmetic part for calculating a temperature or a humidity from said digital signal, a monitoring system including a monitoring device, said monitoring device comprising a contact mechanism for moving contacts according to a calculation result by said arithmetic part.

25. In a power receiving and distributing system including supply equipment of electric power to said monitoring device of said monitoring system set forth in claim 24; load equipment; and power lines for transferring electric power from said supply equipment to said load equipment, a monitoring device comprising:
an input part for inputting a current waveform signal of said receiving and distributing system;
a converter for converting said input signal into a digital signal;
an arithmetic part for calculating a current from said digital signal;
a comparing part for comparing a calculation result of said temperature sensor or said humidity sensor by said arithmetic part set forth in claim 18 with a current value by said arithmetic part; and
a contact mechanism for moving contacts according to a comparison result of said comparing part monitoring device.

26. In a power receiving and distributing system including supply equipment of electric power to said monitoring device of said monitoring system set forth in claim 24; load equipment; and power lines for transferring electric power from said supply equipment to said load equipment, a monitoring device comprising:
an input part for inputting a leakage current waveform signal of a power receiving and distributing system;
a converter for converting said input signal into a digital signal;
an arithmetic part for calculating a leakage current from said digital signal;
a comparing part for comparing a calculation result of said temperature sensor or said humidity sensor by said arithmetic part set forth in claim 18 with a current value by said arithmetic part; and
a contact mechanism for moving contacts according to a comparison result of said comparing part.

27. In an embodiment of a monitoring device including a plurality of said circuit breakers set forth in claim 20; an input part for inputting a plurality of signals from said temperature sensor or said humidity sensor; a converter for converting said input signal into a digital signal; and an arithmetic part for calculating a temperature or humidity from said digital signal, a monitoring system including a monitoring device, said monitoring device comprising:
a contact mechanism for moving contacts according to a calculation result by said arithmetic part.

28. In an embodiment of a monitoring device including a plurality of said circuit breakers set forth in claim 22; an input part for inputting a plurality of signals from said temperature sensor or said humidity sensor; a converter for converting said input signal into a digital signal; and an arithmetic part for calculating a temperature or humidity from said digital signal, a monitoring system including a monitoring device, said monitoring device comprising:
a contact mechanism for moving contacts according to a calculation result by said arithmetic part.

29. In a power receiving and distributing system includes supply equipment of electric power to said monitoring device of said monitoring system set forth in claim 24; load equipment; and power lines for transferring electric power from said supply equipment to said load equipment, a monitoring device comprising:
an input part for inputting a plurality of current waveform signals of said power receiving and distributing system;
a converter for converting said input signal into a digital signal;
an arithmetic part for calculating a current from said digital signal;
a comparing part for comparing a calculation result of said temperature sensor or said humidity sensor by said arithmetic part set forth in claim 18 with a current value by said arithmetic part; and
a contact mechanism for moving contacts according to a comparison result of said comparing part monitoring device.

30. In a power receiving and distributing system including supply equipment of electric power to said monitoring device of said monitoring system set forth in claim 24; load equipment; and power lines for transferring electric power from said supply equipment to said load equipment, a leakage monitoring device comprising:
an input part for inputting a plurality of leakage current waveform signals of said power receiving and distributing system;
a converter for converting said input signal into a digital signal;
an arithmetic part for calculating a leakage current from said digital signal;
a comparing part for comparing a calculation result of said temperature sensor or said humidity sensor by said arithmetic part set forth in claim 18 with a current value by said arithmetic part; and
a contact mechanism for moving contacts according to a comparison result of said comparing part.

31. In a power receiving and distributing system including electric power supply equipment, load equipment, and power lines for transferring electric power from said supply equipment to said load equipment, a leakage monitoring device comprising:
an input part for inputting a voltage waveform signal and a leakage current waveform signal of a power receiving and distributing system;
a converter for converting said input signal into a digital signal;
an arithmetic part for calculating a leakage current of a resistive component from said digital signal; and
an input part of said voltage waveform signal which is capable of inputting different voltages of at least two or more circuits.

32. In a power receiving and distributing system including electric power supply equipment, load equipment, and power lines transferring electric power from said supply equipment to said load equipment, a leakage monitoring system including a leakage monitoring device including a circuit breaker having a switch part for turning on and off a load current of a main circuit and a tripping mechanism for turning on and off said switch part by a signal from outside; an input part capable of inputting a leakage current waveform signal of a power receiving and distributing system; a converter for converting said input signal into a digital signal; an arithmetic part for calculating a leakage current from said digital signal; and a contact mechanism for moving contacts according to a calculation result of said arithmetic part,
wherein said contact mechanism of said leakage monitoring device is connected to a tripping mechanism of said circuit breaker, the contacts are operated according to a calculation result of said leakage monitoring device, and the switch part of said circuit breaker is turned on or off by the tripping mechanism of said circuit breaker.

33. In a power receiving and distributing system including electric power supply equipment, load equipment, and power lines transferring electric power from said supply equipment to said load equipment, an insulation monitoring device comprising:
means for inputting a leakage current signal of said power receiving and distributing system;
means for inputting a load operating signal from each load;
means for setting a monitor value to determine an insulation condition;
means for deciding that the insulation is abnormal when an input value of said leakage current signal is larger than said set monitor value;
means for detecting an operating load from said load operating signal and deciding that the load is abnormal when a decision is made that the insulation is abnormal;
means for indicating an alarm when a decision is made that the insulation is abnormal; and
means for outputting an alarm signal when a decision is made that the insulation is abnormal.

34. The insulation monitoring device according to claim 33, wherein means is provided for determining the operating state of a load from said load operating signal, means is provided for accumulating operating time, means is provided for
calculating operating time for each load, and means is provided for deciding a remaining period until update time.
